(19) United States
(12) Patent Application Publication
(10) Pub. No.: US 2011/0293167 A1
(43) Pub. Date: Dec. 1, 2011

(54) DEFECT INSPECTING METHOD, DEFECT INSPECTING APPARATUS, AND RECORDING MEDIUM

(75) Inventor: Hiroyuki HAYASHI, Mie (JP)

(73) Assignee: Kabushiki Kaisha Toshiba, Tokyo (JP)

(21) Appl. No.: 13/052,160

(22) Filed: Mar. 21, 2011

(30) Foreign Application Priority Data
May 28, 2010 (JP) 2010-122855

(51) Int. Cl. G06K 9/00

(52) U.S. Cl. 382/149

(57) ABSTRACT

According to one embodiment, a defect inspecting method includes: separately detecting an amount of first secondary electrons emitted from a semiconductor substrate at a first elevation angle and an amount of second secondary electrons emitted at a second elevation angle different from the first elevation angle; creating potential contrast images respectively from the detected amounts of the first and second secondary electrons; determining a combination ratio of the created respective potential contrast images; combining the potential contrast images respectively created from the first and second secondary electrons at the determined combination ratio; and extracting a defect based on the combined potential contrast image. The determining a combination ratio includes: calculating the luminance of the bottom between the wires; determining whether the calculated luminance exceeds a predetermined reference value; and changing the combination ratio when the calculated luminance does not exceed the predetermined reference value.

### CROSS-REFERENCE TO RELATED APPLICATIONS

This application is based upon and claims the benefit of priority from the prior Japanese Patent Application No. 2010-122855, filed on May 28, 2010; the entire contents of which are incorporated herein by reference.

### FIELD

Embodiments described herein relate generally to a defect inspecting method, a defect inspecting apparatus, and a recording medium.

### BACKGROUND

To detect electric characteristic failures such as short circuit and disconnection of wires of a semiconductor integrated circuit, a defect inspecting apparatus of a scanning electron microscope (SEM) type (hereinafter simply referred to as “defect inspecting apparatus”) is useful.

The defect inspecting apparatus scans an electron probe on a wafer surface, detects secondary electrons emitted from positions on the wafer surface, and gives luminance corresponding to an amount of the detected secondary electrons to pixels corresponding to scanning positions to create a potential contrast image. For example, according to a die-to-die image comparison inspection system, the defect inspecting apparatus compares a potential contrast image obtained from a wiring surface present on an inspection target chip (die) in a wafer surface and a potential contrast image on a wiring surface in the same region on a die formed adjacent to the inspection target die on the wafer to extract a defect from the inspection target die. When a die on which repeated wires are present such as a memory device, in some case, a cell-to-cell image comparison inspection system for comparing potential contrast images between cells adjacent to each other is adopted.

When wires are formed on a wafer, in some case, a wire material remains on the bottom between the wires because of excessive film formation or insufficient etching of the wire material and short circuit occurs. In a short-circuit section due to such an etching residue, signal intensity of a potential contrast image is low. Therefore, the short circuit section is less easily detected as a defect.

### BRIEF DESCRIPTION OF THE DRAWINGS

FIG. 1 is a diagram of the configuration of a defect inspecting apparatus according to an embodiment;

FIG. 2 is a diagram of an example of a semiconductor substrate in a state in which gate wires of a memory cell array are formed;

FIG. 3 is a diagram of an example of the semiconductor substrate in a state in which the gate wires of the memory cell array are formed;

FIG. 4 is a diagram of a potential contrast image;

FIG. 5 is a diagram for explaining functional components of a control computer;

FIGS. 6A and 6B are diagrams for explaining a defect detecting system;

FIG. 7 is a diagram for explaining an example of a hardware configuration of the control computer;

FIG. 8 is a flowchart for explaining an overview of a defect detecting method according to the embodiment;

FIG. 9 is a flowchart for explaining combination ratio determination processing;

FIG. 10 is a diagram of a potential contrast image;

FIGS. 11A and 11B are diagrams for explaining a difference in a combination ratio;

FIGS. 12A and 123 are diagrams for explaining the difference in the combination ratio;

FIG. 13 is a flowchart for explaining defect detection processing;

FIG. 14 is a diagram of an example of a two-dimensional histogram;

FIG. 15 is a diagram of a potential contrast image (a plan view) obtained from a gate wire in which a bump occurs;

FIG. 16 is a diagram of the potential contrast image (an oblique view) obtained from the gate wire in which the bump occurs; and

FIG. 17 is a diagram of a combined image.

### DETAILED DESCRIPTION

In general, according to one embodiment, a defect inspecting method for scanning an electron beam on a semiconductor substrate, on which wires are formed, and performing, based on an amount of secondary electrons emitted from the semiconductor substrate, a defect inspection for the wires includes; separately detecting an amount of first secondary electrons emitted from the semiconductor substrate at a first elevation angle and an amount of second secondary electrons emitted at a second elevation angle different from the first elevation angle; creating potential contrast images respectively from the detected amounts of the first and second secondary electrons; determining a combination ratio of the created respective potential contrast images; combining the potential contrast images respectively created from the first and second secondary electrons at the determined combination ratio; and extracting a defect by comparing the combined potential contrast image with a reference image. The determining a combination ratio includes: calculating the luminance of the bottom between the wires; determining whether the calculated luminance exceeds a predetermined reference value; and changing the combination ratio when the calculated luminance does not exceed the predetermined reference value.

Exemplary embodiments of a defect inspecting method, a defect inspecting apparatus, and a recording medium will be explained below in detail with reference to the accompanying drawings. The present invention is not limited to the following embodiments.

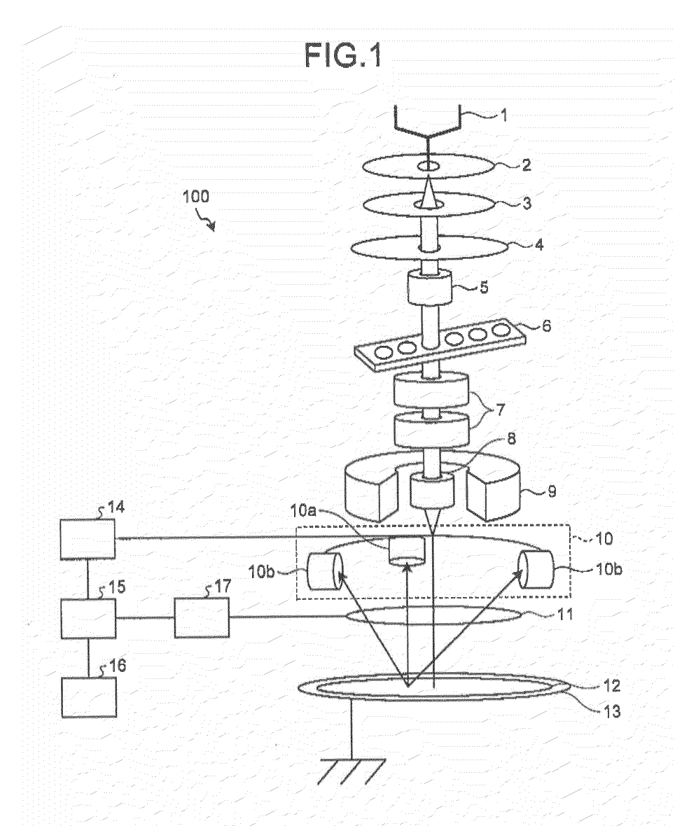

FIG. 1 is a diagram of the configuration of a defect inspecting apparatus according to an embodiment of the present invention. As shown in the figure, a defect inspecting apparatus 100 includes a filament electrode 1, a suppressor electrode 2, an extractor electrode 3, a condensing lens 4, a Wien filter 5, an aperture 6, beam scanning deflectors 7, a Wien filter 8, an object lens 9, a secondary electron detector 10, a secondary electron control electrode 11, a substrate stage 13, a signal processing device 14, a control computer 15, a display device 16, and a DC power supply 17.

The filament electrode 1 emits an electron beam. The electron beam emitted from the filament electrode 1 is extracted by the extractor electrode 3 via the suppressor electrode 2 that suppresses the spread of the electron beam. The electron beam is condensed by the condensing lens 4. The electron beam condensed by the condensing lens 4 is subjected to position correction by the Wien filter 5 to pass the center of the aperture 6. The beam diameter of the electron beam is shaped into an aperture size by the aperture 6.

A semiconductor substrate 12 on which wires are formed is stacked on the substrate stage 13. The electron beam shaped by the aperture 6 is irradiated on the surface of the semiconductor substrate 12 via the beam scanning deflectors 7, the Wien filter 8, and the object lens 9. The beam scanning deflectors 7 deflect the electron beam such that an irradiation position of the electron beam scans the surface of the semiconductor substrate 12. The Wien filter 8 performs position correction for the electron beam such that the electron beam passes the center of the object lens 9. The electron beam irradiated on the semiconductor substrate 12 is also referred to as primary electron beam.

The irradiation position of the electron beam is scanned on the semiconductor substrate 12 by the action of the beam scanning deflectors 7. Secondary electrons are emitted from the position of the semiconductor substrate 12 where the primary electron beam is irradiated. The secondary electrons emitted from the semiconductor substrate 12 are extracted by the secondary electron control electrode 11 to which a voltage is applied by the DC power supply 17. The secondary electrons are made incident on the secondary electron detector 10. The secondary electron detector 10 sequentially detects amounts of the incident secondary electrons for respective radiation positions changed every moment by the scanning.

Detection results for the respective irradiation positions obtained by the secondary electron detector 10 are sequentially sent to the signal processing device 14. The signal processing device 14 sequentially converts the received detection results into image signals. The control computer 15 generates, based on the image signals sequentially converted by the signal processing device 14, a potential contrast image in a scanning range of the semiconductor substrate 12, and outputs the generated potential contrast image to and displays the generated potential contrast image on the display device 16. The display device 16 can be a liquid crystal display, a cathode ray tube (CRT) display, or the like.

The electron beams are emitted from the wafer surface toward various angles (an elevation angle and an azimuth angle). In particular, when there is a local gradient in a position on which the primary electron beam is made incident, a largest amount of the secondary electrons are emitted in a vertical direction of an incident surface of the primary electron beam.

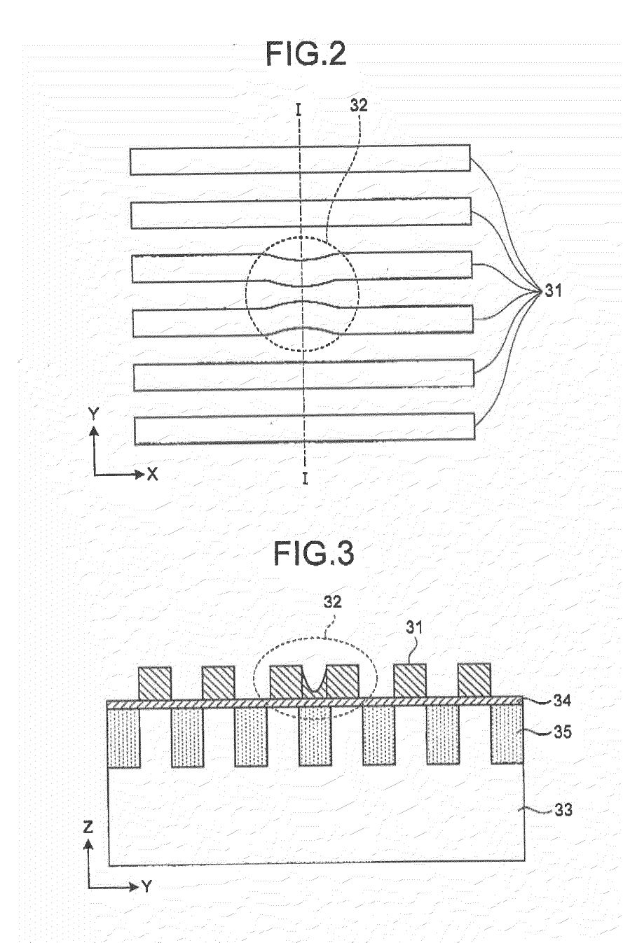

FIGS. 2 and 3 are diagrams of an example of the semiconductor substrate 12 in a state in which gate wires of a memory cell array are formed. FIG. 2 is a top view of the semiconductor substrate 12. FIG. 3 is a sectional view of the semiconductor substrate 12 taken along surface I-I shown in FIG. 2. As shown in the figures, a gate oxide film 34 is formed on a Si substrate 33. A plurality of gate wires 31 in an X axis direction are formed on the gate oxide film 34 in a Y axis direction. Insulating films 35 functioning as sources or drains are generated under the gate oxide film 34 in positions across the gate wires 31 viewed from above a Z axis. In a region 32 in the figures, a space between the gate wires 31 is narrower than that in other regions. Sidewalls of the two gate wires 31 in the region 32 are respectively formed in slopes. The lower edges of the sidewalls are short-circuited each other between the gate wires 31 to form a bridge defect. Such a bridge defect occurs when a residue of a gate wire material remains on the bottom between the wires because of excessive film formation or insufficient etching of the gate wire material.

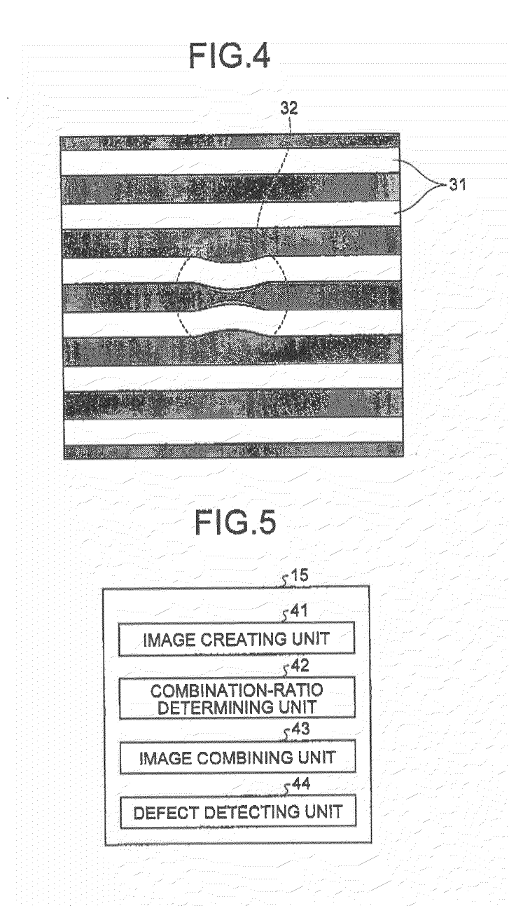

FIG. 4 is a diagram of a contrast image generated by detecting secondary electrons emitted in a right upward direction (i.e., a direction of an elevation angle of 90 degrees, in other words, upward in the Z axis direction) from the semiconductor substrate shown in FIGS. 2 and 3. According to the potential contrast image, it is seen that shape of the upper surface of the gate wires 31 in the region 32 is narrowed. However, the signal intensity of the sidewalls in the slopes of the gate wires 31 in the region 32 is weak. Therefore, it is difficult to determine whether a bridge is formed between the wires.

In this way, there is a defect that the signal intensity is too small and a detection ratio is low in the potential contrast image obtained from the secondary electrons emitted right upward. Therefore, in this embodiment, not only the secondary electrons emitted in the right upward direction but also secondary electrons emitted in an obliquely upward direction are detected. Potential contrast images respectively created from the detected secondary electrons emitted in the right upward direction and the obliquely upward direction are combined as one potential contrast image. This makes it possible to detect a defect such as the bridge defect that tends to be overlooked because the signal intensity is too small in a potential contrast image obtained from secondary electrons emitted at an elevation angle of about 90 degrees.

Specifically, the secondary electron detector 10 includes a secondary electron detector 10a that detects secondary electrons emitted in the vertical direction from an irradiation position of a primary electron beam and a secondary electron detector 10b that detects secondary electrons emitted in the obliquely upward direction from the irradiation position. As shown in FIG. 5, the control computer 15 includes, as functional components for performing defect detection based on image signals from the secondary electron detectors 10a and 10b, an image creating unit 41 that creates, based on the image signals from the secondary electron detectors 10a and 10b, potential contrast images separately from each other, a combination-ratio determining unit 42 that determines a combination ratio of two potential contrast images created by the image creating unit 41, an image combining unit 43 that combines the two potential contrast images at the combination ratio determined by the combination-ratio determining unit 42, and a defect detecting unit 44 that performs defect detection using an image contrast image created by the image combining unit 43 by combining the two potential contrast images.

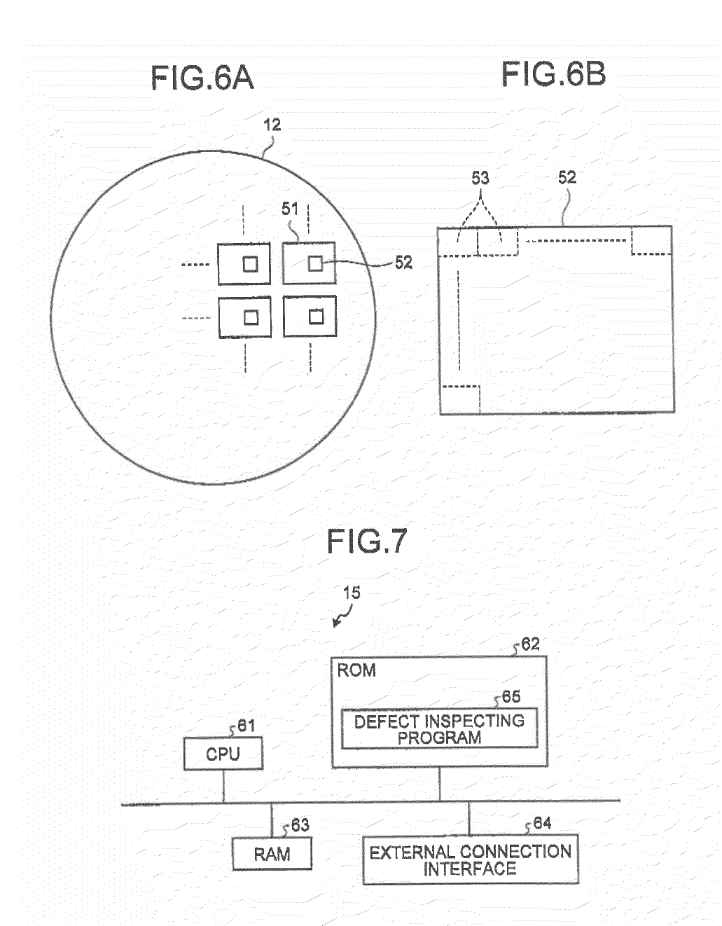

It is assumed that a cell-to-cell image comparison system is applied to the defect detecting unit 44 as a defect detection system. FIGS. 6A and 6B are diagrams for explaining the defect detection system of the defect detecting unit 44. FIG. 6A is a top view of the entire semiconductor substrate 12. As shown in the figure, a large number of dies 51 are formed on the semiconductor substrate 12. Memory cell arrays 52 are respectively formed in the dies 51. FIG. 6B is a diagram of the memory cell array 52. As shown in the figure, the memory cell array 52 is larger than the size of areas (scan areas) 53 where a potential contrast image can be acquired by performing scanning once. Therefore, the entire memory cell array 52 is inspected by performing a scanning operation a plurality of times. According to the cell-to-cell image comparison system, potential contrast images are sequentially compared among the scan areas 53 adjacent to one another and a defective section is extracted based on a comparison result.

The functional components of the control computer 15 are realized by hardware having a normal computer configuration. FIG. 7 is a diagram for explaining an example of a hardware configuration of the control computer 15. As shown in the figure, the control computer 15 includes a central processing unit (CPU) 61, a read only memory (ROM) 62, a random access memory (RAM) 63, and an external connection interface 64. The CPU 61, the ROM 62, the RAM 63, and the external connection interface 64 are connected to one another via a bus line.

The CPU 61 executes a defect inspecting program 65, which is a computer program for executing the defect inspecting method according to this embodiment. The external connection interface 64 is an interface to which an input device (not shown) such as a mouse and a keyboard and the display device 16 are connected. Operation information concerning the control computer 15 from a user is input to the input device. The input operation information is sent to the CPU 61.

The defect inspecting program 65 includes the functional components explained above (the image creating unit 41, the combination-ratio determining unit 42, the image combining unit 43, and the defect detecting unit 44). The defect inspecting program 65 is stored in the ROM 62. The defect inspecting program 65 is loaded onto the RAM 63 by the CPU 61, whereby the image creating unit 41, the combination-ratio determining unit 42, the image combining unit 43, and the defect detecting unit 44 are generated on the RAM 63. An image signal from the image processing device 14 and intermediate data generated by the functional components based on the image signal are stored in a work area provided in the RAM 63. A potential contrast image after combination and a defect detection result are output to the display device 16 via the external connection interface 64. A rewritable storage device such as a hard disk drive or a solid state drive (SSD) can be connected to the external connection interface 64 and a work area can be secured in the storage device. The potential contrast image after combination and the defect detection result can be output to the storage device.

The defect inspecting program 65 can be stored in the storage device. The defect inspecting program 65 can be loaded to the storage device. The defect inspecting program 65 can be stored on a computer connected to a network such as the Internet and can be provided or distributed by being downloaded through the network. The defect inspecting program 65 can be incorporated in the ROM 62 or the like in advance and provided to the defect inspecting apparatus 100.

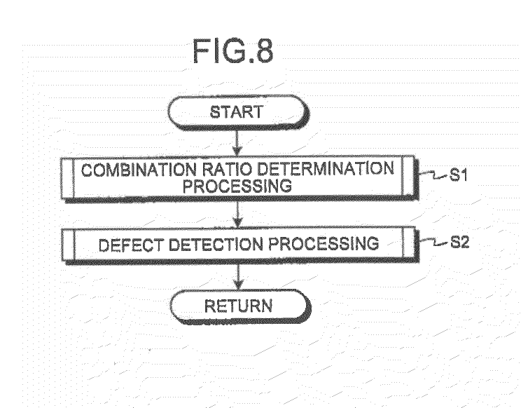

The defect inspecting method according to this embodiment executed using the defect inspecting apparatus 100 configured as explained above is explained below. FIG. 8 is a flowchart for explaining an overview of the defect inspecting method according to this embodiment. In the explanation, a defect inspection in one memory cell array 52 is performed. As shown in FIG. 8, first, processing for determining a combination ratio (combination ratio determination processing) is executed (step S1).

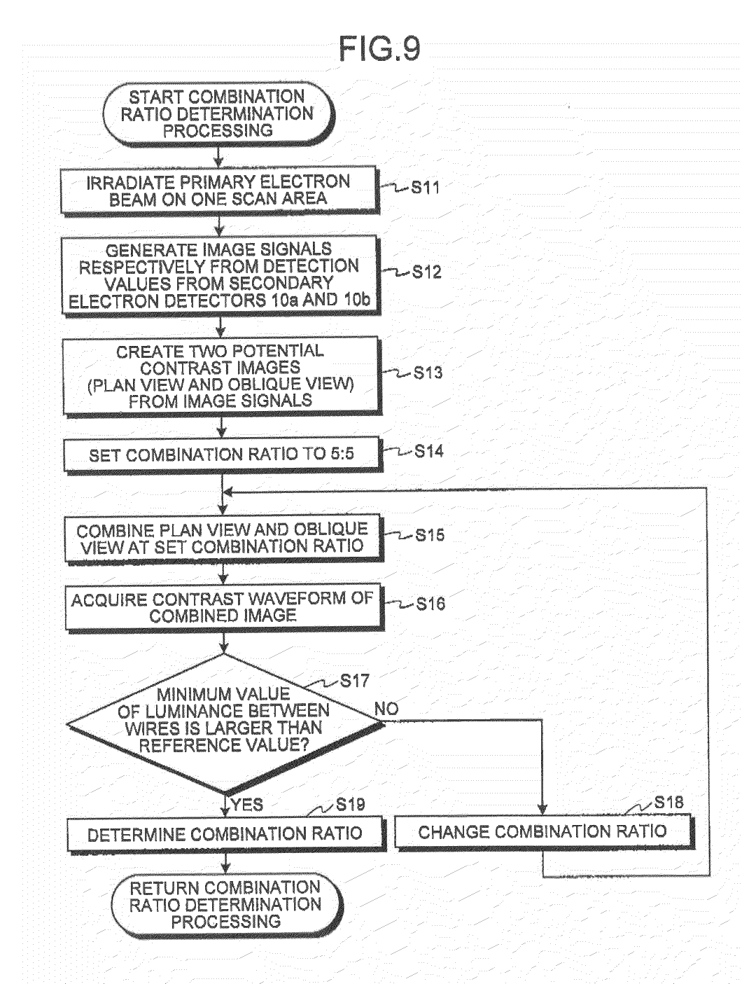

FIG. 9 is a diagram for explaining the combination ratio determination processing. As shown in the figure, first, one scan area is scanned by a primary electron beam (step S11). Then, the secondary electron detectors 10a and 10b output detection results of secondary electrons for respective irradiation positions. The signal processing device 14 sequentially converts detection values sequentially sent for the respective irradiation positions from the secondary electron detectors 10a and 10b into image signals (step S12). For example, the signal processing device 14 converts the detection values from the secondary electron detectors 10a and 10b into luminances for the respective irradiation positions and sequentially outputs the luminances in the respective irradiation positions based on the detection values of the irradiated secondary electron detectors 10a and 10b. As an example, it is assumed that the luminances as the image signals from the image processing device 14 are information concerning a single color with 256 gradations.

The image creating unit 41 creates, based on the image signals sent from the signal processing device 14, a potential contrast image based on the detection values of the secondary electron detector 10a and a potential contrast image based on the detection values of the secondary electron detector 10b (step S13). The former potential contrast image is referred to as plan view and the potential contrast image is referred to as oblique view.

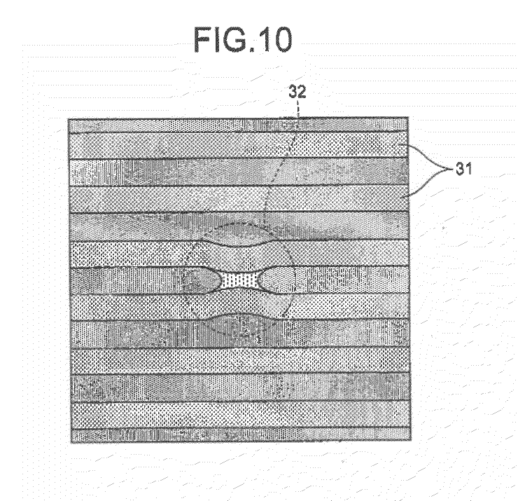

FIG. 10 is a diagram of a potential contrast image (an oblique view) obtained from the semiconductor substrate shown in FIGS. 2 and 3. A plan view of the semiconductor substrate is as shown in FIG. 4. The wall surfaces of the gate wires 31 forming the bridge defect in the region 32 displayed dark in the plan view are displayed bright in the oblique view compared with the upper surfaces of the gate wires 31. It can be discriminated that the wall surfaces are short-circuited between the gate wires 31.

Subsequent to step S13, the combination-ratio determining unit 42 sets a ratio of 5:5 as a combination ratio in an initial state (step S14). The image combining unit 43 combines the plan view and the oblique view at the set combination ratio (step S15).

The image-ratio determining unit 42 creates, concerning pixels located on a predetermined straight line orthogonal to gate wires in a combined image, a graph in which luminance is plotted as the ordinate, one end of the straight line is plotted as the origin, and a distance from the origin position is plotted as the abscissa (hereinafter simply referred to as contrast waveform) (step S16). The combination-ratio determining unit 42 calculates the luminance of the bottom between the wires (bottom luminance) from the created contrast waveform and determines whether the calculated bottom luminance is larger than a reference value set in advance (step S17). When the bottom luminance is smaller than the reference value (No at step S17), the combination-ratio determining unit 42 changes the combination ratio (step S18) and shifts to the processing at step S15.

In most cases, concerning a section without a tilt, a difference in light and shade in the Z axis direction tends to be larger in the plan view than in the oblique view. Specifically, the upper surface sections of the gate wires 31 in the plan view are brighter than the upper surface sections of the gate wires 31 in the oblique view. The bottom between the gate wires 31 in the plan view tends to be darker than the bottom between the gate wires 31 in the oblique view. Therefore, when the combination ratio is changed to increase a percentage of the oblique view, the bottom luminance rises. When the percentage of the oblique view increases, the signal intensity of the slopes is improved. As a result, it is easy to discriminate a defect including the slopes such as a bridge defect in defect detection processing explained later. Detection accuracy of the defect is improved. The user sets the reference value to an appropriate value such that the defect such as the bridge defect can be detected at desired detection accuracy.

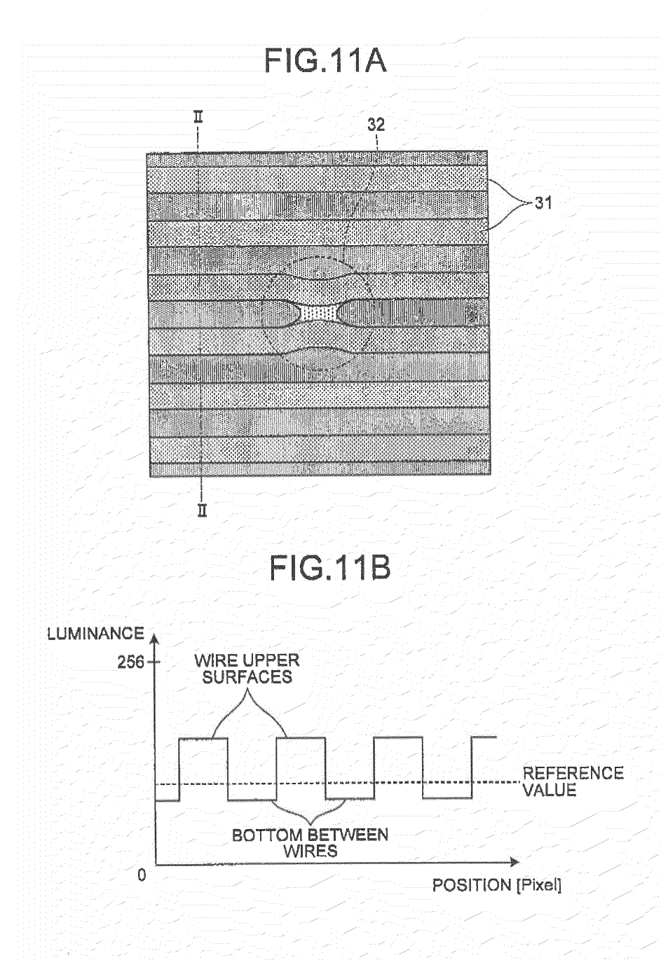

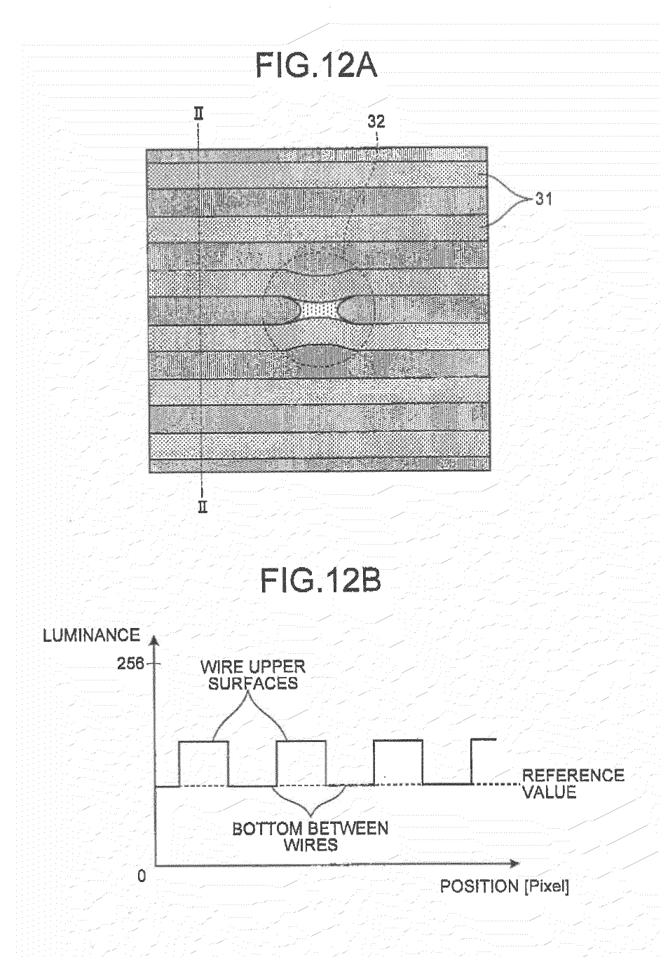

A difference in a combination ratio is explained with reference to FIGS. 11A and 11B and FIGS. 12A and 12B. FIG. 11A is a diagram of a combined image created at a combination ratio of 5:5. FIG. 11B is a diagram of a contrast waveform created from pixels located on line II-II in the combined image. In FIG. 11A, both the shape of the gate wire upper surfaces in the region 32 and the shape of the sidewalls in the region 32 are shown. However, as shown in FIG. 11B, the bottom luminance is equal to or lower than the reference value. Therefore, it is seen that FIG. 11A is a combined image in which detection accuracy of a defect more easily detected in a side view does not reach a level desired by the user.

FIG. 12A is a diagram of a combined image created at a ratio 4:6 of the plan view and the oblique view. FIG. 12B is a diagram of a contrast waveform created from pixels located on line II-II in the combined image. As shown in FIG. 12B, the bottom luminance reaches the reference value. It is seen that FIG. 12A is a combined image in which detection accuracy of a defect more easily detected in a side view reaches a level desired by the user.

A method of calculating bottom luminance by the combination-ratio determining unit 42 is not specifically limited. For example, the combination-ratio determining unit 42 can simply set a lowest value of the contrast waveform as the bottom luminance. The combination-ratio determining unit 42 can set a lowest value after removal of a noise component from the contrast waveform as the bottom luminance. The combination-ratio determining unit 42 can directly calculate the bottom luminance from the combined image without creating the contrast waveform.

When the combined image having the bottom luminance larger than the reference value is obtained (Yes at step S17), the combination ratio set at the present point is determined as a combination ratio used in one memory cell array 52 (step S19). The combination ratio determination processing is returned to the start.

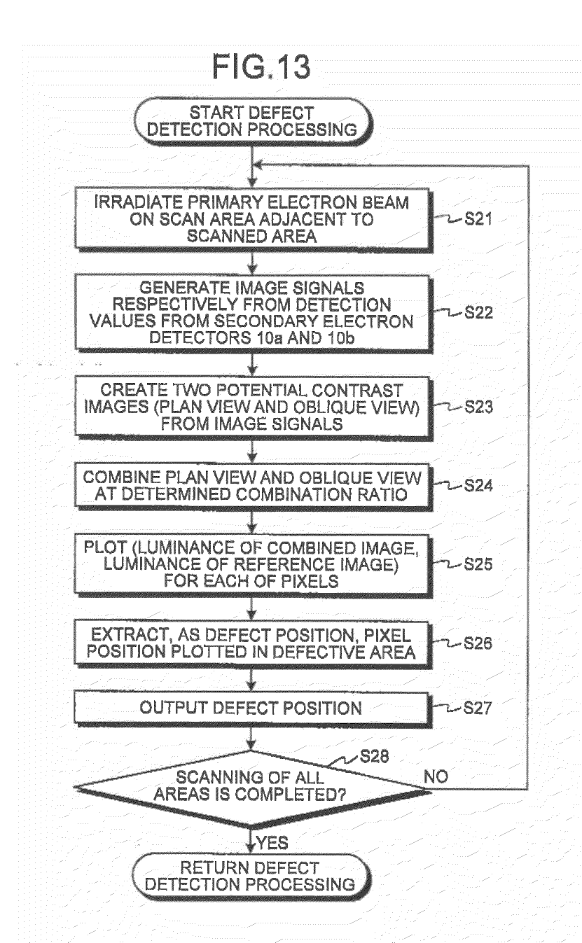

After the combination ratio determination processing, processing for performing defect detection using the determined combination ratio (defect detection processing) is executed (step S2). FIG. 13 is a flowchart for explaining the defect detection processing.

As shown in FIG. 13, first, a primary electron beam is irradiated on the scan area 53 adjacent to the already-scanned scan area 53 (step S21). The signal processing device 14 sequentially converts detection values sequentially sent for respective irradiation positions from the secondary electron detectors 10a and 10b into image signals (step S22). The image creating unit 41 creates, based on the image signals sent from the signal processing device 14, a plan view and an oblique view (step S23). The combination-ratio determining unit 42 combines the plan view and the oblique view at the combination ratio determined by the combination ratio determination processing (step S24).

The defect detecting unit 44 generates a luminance distribution chart (a two-dimensional histogram) in which luminances of respective pixels are plotted with the luminance of the combined image generated at step S24 and the luminance of a combined image (a reference image) of the already-scanned scan area 53 respectively set as coordinate components (step S25). The defect detecting unit 44 extracts a pixel plotted in a predetermined area in the two-dimensional histogram as a pixel in a defect position (step S26) and outputs the extracted pixel position as a defect detected from the scan area 53 already scanned at step S11 (step S27).

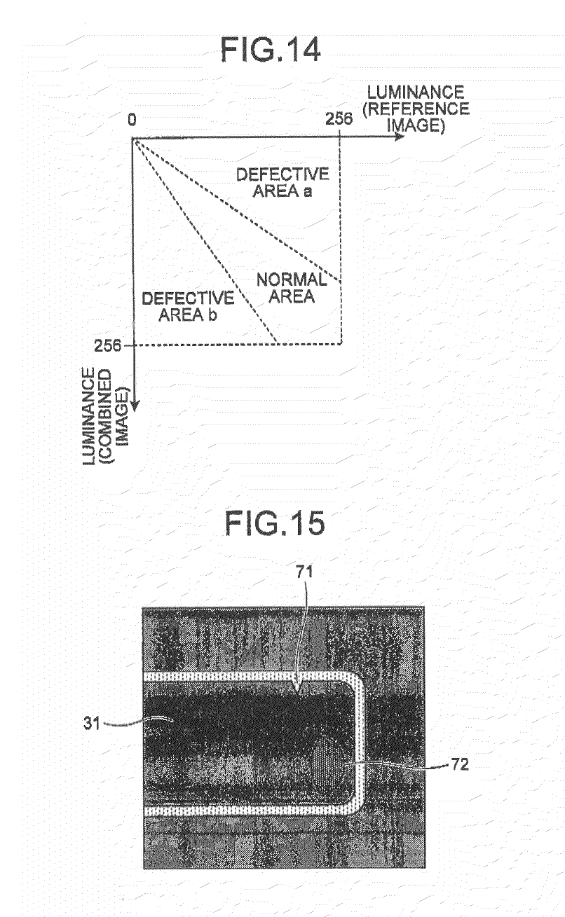

FIG. 14 is a diagram of an example of the two-dimensional histogram. In the figure, a luminance distribution is plotted with the luminance of the reference image set as an X component and the luminance of the combined coordinate generated at step S24 set as a Y component. In a section where a defect does not occur, the luminance of the created combined image and the luminance of the reference image substantially coincide with each other. Therefore, the section is plotted on a straight line of X=Y. A section where a defect occurs is plotted in a section deviating from X=Y. An area obtained by giving a certain degree of margin to X=Y is set as a normal area. A position corresponding the a pixel plotted in a section (a defective area “a” or a defective area “b”) deviating from the normal area is extracted as a defect position. When disconnection of wires occurs, a pixel in a disconnected section is plotted in the defective area “a”. When short-circuit such as a bridge defect occurs, a pixel in a short-circuit section is plotted in the defective area “b”.

The defect detecting unit 44 determines whether scanning of all areas of the memory cell array 52 is completed (step S28). When the scanning is completed (Yes at step S28), the defect detection processing is returned to the start. When the scanning is not completed (No at step S28), the processing shifts to step S21. When the defect detection processing is returned to the start, the defect detecting method for the memory cell array 52 ends.

In the above explanation of the example, the memory cell array 52 is subjected to the defect inspection using the cell-to-cell image comparison system. However, concerning a logic circuit section other than the memory cell array 52 of the die 51, it is advisable to perform the defect inspection using a die-to-die image comparison system for setting a potential contrast image after combination of a die adjacent to an inspection target die as a reference image and comparing the reference image with a combined image of the inspection target die. The entire die 51 including the memory cell array 52 can be subjected to the defect inspection using the die-to-die image comparison system. When the cell-to-cell image comparison system and the die-to-die image comparison system are adopted, a potential contrast image used as a reference image does not always have to be a potential contrast image of an adjacent scan area or die.

As explained above, in the oblique view, the shape of the slopes are enhanced. Therefore, in this embodiment, detection accuracy for not only the bridge defect but also a convex shape defect (a bump) that occurs on the gate wires 31 is improved.

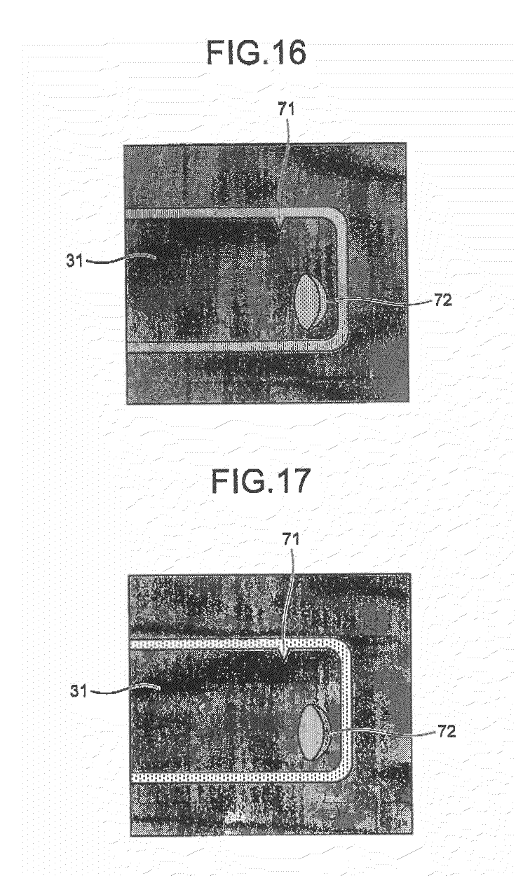

FIG. 15 is a diagram of a plan view obtained from the gate wire 31 on which a bump occurs. FIG. 16 is an oblique view obtained from the gate wire 31. A cutout 71 and a bump 72 are formed on the upper surface of the gate wire 31. According to the plan view, the cutout 71 is clearly represented and, on the other hand, a difference in signal intensity is small in the bump 72 compared with the gate wire 31 in the background. It is difficult to discriminate whether the bump 72 occurs. According to the oblique view, it is difficult to discriminate the shape of the cutout 71 and a tilting section of the bump 72 is enhanced. As a result, it is easy to recognize the presence of the bump 72.

FIG. 17 is a diagram of a combined image obtained by combining FIGS. 15 and 16. As shown in FIG. 17, according to the combined image, it is easy to discriminate both the cutout 71 and the bump 72. In other words, both of the cutout 71 and the bump 72 are easily detected as defects.

In the above explanation, the potential contrast images are respectively created from the secondary electrons emitted at the elevation angle of 90 degrees and the secondary electrons emitted at the elevation angle different from 90 degrees. However, one of the elevation angels does not necessarily be 90 degrees. Potential contrast images can be respectively created from secondary electrons emitted at two kinds of elevation angles different from 90 degrees. Fixed margins can be respectively given to elevation angles of secondary electrons respectively detected by the secondary electron detectors 10a and 10b. Potential contrast images can be respectively created from secondary electrons emitted at three or more kinds of elevation angles. Created three or more potential contrast images can be combined.

As explained above, according to this embodiment, an amount of first secondary electrons emitted at a first elevation angles from the semiconductor substrate 12 and an amount of second secondary electrons emitted at a second elevation angle from the semiconductor substrate 12 are separately detected. Potential contrast images are respectively created from the detected amounts of the first and second secondary electrons. A combination ratio of the created potential contrast images is determined such that bottom luminance between wires exceeds a predetermined reference value. The potential contrast images are combined at the determined combination ratio. A defect is extracted by comparing a combined image and a reference image. Therefore, because the defect can be extracted based on the combined image in which a bridge defect and the shape of a bump are enhanced, accuracy of detecting the bridge defect and the shape of the bump is improved. In other words, it is possible to highly accurately detect the defect.

Because the first elevation angle is 90 degrees, the potential contrast image (a plan view) obtained based on the secondary electrons emitted at the first elevation angle is an image in which the shape of a surface without a tilt is intensely represented. As a result, it is also possible to accurately detect a defect related to the shape of the surface without a tilt.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A defect inspecting method for scanning an electron beam on a semiconductor substrate, on which wires are formed, and performing, based on an amount of secondary electrons emitted from the semiconductor substrate, a defect inspection for the wires, the defect inspecting method comprising:
separately detecting, by a secondary-electron detecting unit, an amount of first secondary electrons emitted from the semiconductor substrate at a first elevation angle and an amount of second secondary electrons emitted at a second elevation angle different from the first elevation angle;
creating, by an image creating unit, potential contrast images respectively from the detected amounts of the first and second secondary-electrons;
determining, by a combination-ratio determining unit, a combination ratio of the created respective potential contrast images;
combining, by an image combining unit, the potential contrast images respectively created from the first and second secondary electrons at the determined combination ratio; and
extracting, by a defect detecting unit, a defect by comparing the combined potential contrast image with a reference image, wherein
the determining a combination ratio includes:
calculating luminance of a bottom between the wires;
determining whether the calculated luminance exceeds a predetermined reference value; and
changing the combination ratio when the calculated luminance does not exceed the predetermined reference value.

2. The defect inspecting method according to claim 1, wherein the first elevation angle is 90 degrees.

3. The defect inspecting method according to claim 1, wherein the extracting a defect includes:
creating a histogram in which an appearance frequency of luminance of each of pixels is plotted with luminance of the combined potential contrast image and luminance of the reference image set as coordinate components; and
extracting, as a defect position, a position corresponding to a pixel plotted in a predetermined area in the created histogram.

4. The defect inspecting method according to claim 1, wherein extracting a defect uses cell-to-cell image comparison system.

5. A defect inspecting apparatus that scans an electron beam on a semiconductor substrate, on which wires are formed, and performs, based on an amount of secondary electrons emitted from the semiconductor substrate, a defect inspection for the wires, the defect inspecting apparatus comprising:
a secondary-electron detecting unit that separately detects an amount of first secondary electrons emitted from the semiconductor substrate at a first elevation angle and an amount of second secondary electrons emitted at a second elevation angle different from the first elevation angle;
an image creating unit that creates potential contrast images respectively from the detected amounts of the first and second secondary electrons;
a combination-ratio determining unit that determines a combination ratio of the created respective potential contrast images;
an image combining unit that combines the potential contrast images respectively created from the first and second secondary electrons at the determined combination ratio; and
a defect detecting unit that extracts a defect by comparing the combined potential contrast image with a reference image, wherein
the combination-ratio determining unit calculates luminance of a bottom between the wires, determines whether the calculated luminance exceeds a predetermined reference value, and changes the combination ratio when the calculated luminance does not exceed the predetermined reference value.

6. The defect inspecting apparatus according to claim 5, wherein the first elevation angle is 90 degrees.

7. The defect inspecting apparatus according to claim 5, wherein the defect detecting unit creates a histogram in which an appearance frequency of luminance of each of pixels is plotted with luminance of the combined potential contrast image and luminance of the reference image set as coordinate components and extracts, as a defect position, a position corresponding to a pixel plotted in a predetermined area in the created histogram.

8. The defect inspecting apparatus according to claim 5, wherein the secondary-electron detecting unit includes a detector which detects the first secondary electrons and a detector which detects the second secondary electrons.

9. The defect inspecting apparatus according to claim 5, wherein the defect detecting unit uses cell-to-cell image comparison system.

10. The defect inspecting apparatus according to claim 9, wherein the first elevation angle is 90 degrees.

11. A non-transitory computer readable medium comprising instructions that cause a computer to:
create potential contrast images respectively from an amount of first secondary electrons emitted from a semiconductor substrate, on which wires are formed, at a first elevation angle when an electron beam is scanned on the semiconductor substrate and an amount of second secondary electrons emitted at a second elevation angle different from the first elevation angle;
determine a combination ratio of the created respective potential contrast images;
combine the potential contrast images respectively created from the first and second secondary electrons at the determined combination ratio;
extract a defect by comparing the combined potential contrast image with a reference image; and
in determining the combination ratio,
calculate luminance of a bottom between the wires;
determine whether the calculated luminance exceeds a predetermined reference value; and
change the combination ratio when the calculated luminance does not exceed the predetermined reference value.

12. The computer readable medium according to claim 11, wherein the first elevation angle is 90 degrees.

13. The computer readable medium according to claim 12, wherein the extracting a defect includes:
creating a histogram in which an appearance frequency of luminance of each of pixels is plotted with luminance of the combined potential contrast image and luminance of the reference image set as coordinate components; and
extracting, as a defect position, a position corresponding to a pixel plotted in a predetermined area in the created histogram.

14. The computer readable medium according to claim 11, wherein extracting a defect uses cell-to-cell image comparison system.
